(19) United States
(12) Patent Application Publication
(10) Pub. No.: US 2009/0055237 A1
(43) Pub. Date: Feb. 26, 2009

(54) SYSTEM AND METHOD FOR MANAGING INHERENT PROJECT UNCERTAINTY

(76) Inventors: Bruce P. Henry, Seattle, WA (US); Jason Carlson, Seattle, WA (US); Charles A. Seybold, Sammamish, WA (US); Bryan Wilkerson, Seattle, WA (US)

Correspondence Address: PERKINS COIE LLP;PATENT-SEA, P.O. BOX 1247, SEATTLE, WA, 98111-1247, US

(21) Appl. No.: 11/844,219

(22) Filed: Aug. 23, 2007

(51) Int. Cl. G06Q 10/00; G06F 17/18

(52) U.S. Cl. 705/8

(57) ABSTRACT

A software and/or hardware facility for managing project schedules having inherent uncertainty. The facility allows users to create hierarchical data structures to model projects and other collective efforts. The hierarchical data structures contain work items that can represent tasks, collections of tasks and collections of collections and tasks. Each work item can have associated with it an estimate provided by a user, such as a ranged estimate of the amount of work remaining before the work item is completed. Based at least in part on the provided estimate, the facility can calculate expected start and finish dates for each work item. By calculating expected start and finish dates for all or most of the work items in a project, the facility is able to calculate an expected end date for the entire project. By basing the calculation on ranged estimates, the facility can account for the uncertainty inherent in projects.

### CROSS-REFERENCE TO RELATED APPLICATION

This application is related to co-pending U.S. patent application Ser. No. ______ (entitled SYSTEM AND METHOD FOR DISPLAYING INHERENT PROJECT UNCERTAINTY, Attorney Docket No. 63863.8002US00), filed concurrently herewith and incorporated herein in its entirety by reference.

### BACKGROUND

In professional and in personal life, a project can range in size from the very small (e.g., a single person project) to the very large (e.g., a project involving hundreds of individuals or organizations). In order to ensure that projects are completed in a timely fashion, it is increasingly common for individuals and organizations to use project management software to manage projects, especially large ones.

One of the primary functions of existing project management software is to estimate a project's completion date and track progress against milestones. The prevalent method involves decomposing a project into smaller tasks (often referred to as a work breakdown structure or WBS). For each task in the WBS, a user typically specifies one of the following: (1) a start date and an end date, (2) the total effort required to complete the task, or (3) the total duration of the task. Tasks can be made dependent (i.e., one task cannot be started until another task is completed) or independent (i.e., two tasks can be worked on concurrently). One or more individuals is assigned to each task. A schedule for each task is determined based on the time required to complete the task and the task's dependencies. Project management software then determines a schedule for the entire project based on the schedules of its component tasks. In essence, existing project management software employs user-provided inputs regarding component tasks to determine the completion date of the entire project.

There are several flaws with the techniques used by existing project management software, however. A first flaw is that existing techniques rarely determine with any accuracy the completion date of a project. In order to determine a project's completion date, existing techniques assume that each component task's start date and end date is certain. For example, FIGS. 1A and 1B depict graphs 100 and 150 that illustrate task effort and schedule calculation in accordance with existing project management techniques. In FIG. 1A, a project P is composed of two tasks T₁ and T₂. A first task T₁ has a total effort of five days, as represented by bar 105. A second task T₂ is dependent upon task T₁ and has a total effort of three days, as represented by bar 110. Existing project management techniques determine with 100% certainty that the completion date of project P is after eight days, i.e., after the sequential completion date of tasks T₁ and T₂ as represented by bar 115. In FIG. 1B, tasks T₁ and T₂, represented by bars 155 and 160 respectively, are independent tasks that both have a total effort of five days. The completion date of project P is thus after five days as represented by bar 165, i.e., the latest completion date of either of tasks T₁ or T₂. While project planning in accordance with the techniques depicted in FIGS. 1A and 1B makes intuitive sense, in the real world schedules typically slide. For example, the techniques depicted in FIGS. 1A and 1B fail to account for inherent uncertainty as to the start and completion dates of tasks. Because existing techniques fail to account for this uncertainty, they cannot determine with meaningful accuracy a project's end date.

A second flaw with the techniques employed by existing project management software is that it can be difficult to obtain status updates from individuals and/or organizations involved in a project. In the absence of updates, project plans produced by existing project management software become more and more inaccurate over time.

Accordingly, there is a need for project management systems and methods that are not susceptible to the aforementioned problems.

### BRIEF DESCRIPTION OF THE DRAWINGS

FIGS. 1A and 1B illustrate task effort and project schedule determination in accordance with prior art techniques.

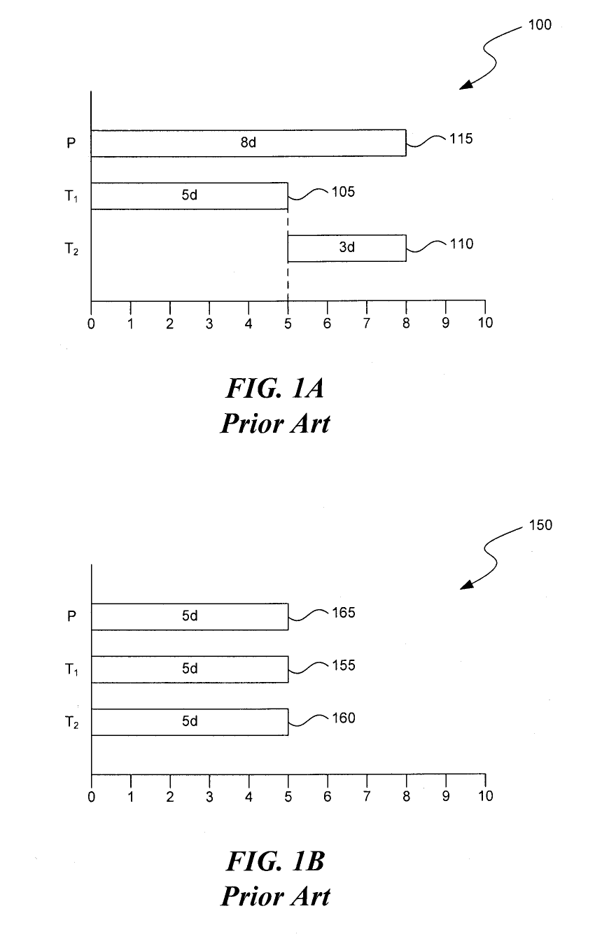

FIG. 2 is a block diagram that illustrates components of a project management facility.

FIG. 3 is a flow diagram of a process for editing a project and calculating a project schedule.

FIG. 4 is a representative screenshot depicting a project management interface.

FIG. 5 is a representative screenshot depicting an interface for editing a project work item.

FIGS. 6A and 6B illustrate task effort and project schedule calculation in accordance with some embodiments of the project management facility.

FIG. 7 is a representative screenshot depicting another project management interface.

FIG. 8 depicts the interface of FIG. 7 illustrating the effect of a revised project schedule.

FIG. 9 depicts the interface of FIG. 7 illustrating a work item promise date.

### DETAILED DESCRIPTION

A software and/or hardware facility for managing project schedules having inherent uncertainty is disclosed. In some embodiments, the facility allows users to create hierarchical data structures to model projects and other collective efforts. The hierarchical data structures contain work items that can represent tasks, collections of tasks and collections of collections and tasks. Each work item can have associated with it an estimate provided by a user, such as a ranged estimate of the amount of work remaining before the work item is completed. Based at least in part on the provided estimate, the facility can calculate expected start and finish dates for each work item. The facility calculates expected start and finish dates for work items that represent collections of tasks and collections of collections and tasks. By calculating the dates for all or most of the work items in a project, the facility is thereby able to calculate an expected end date for the entire project. By calculating expected start and finish dates based on ranged estimates, the facility can account for the uncertainty inherent in projects.

In some embodiments, the facility generates project schedules for display to users that express the uncertainty inherent in projects and component work items. The facility may generate a visual indication of a work item's earliest start date, earliest expected finish date, expected finish date, latest expected finish date and latest finish date. One form that the visual indication can take will be referred to as an “uncertainty bar,” or “u-bar”. A u-bar can be generated for each work item that represents a task, as well as each work item that represents collections of tasks and collections of collections and tasks. The facility can also generate a u-bar for an entire project. The facility can thus visually display the uncertainty inherent in projects.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

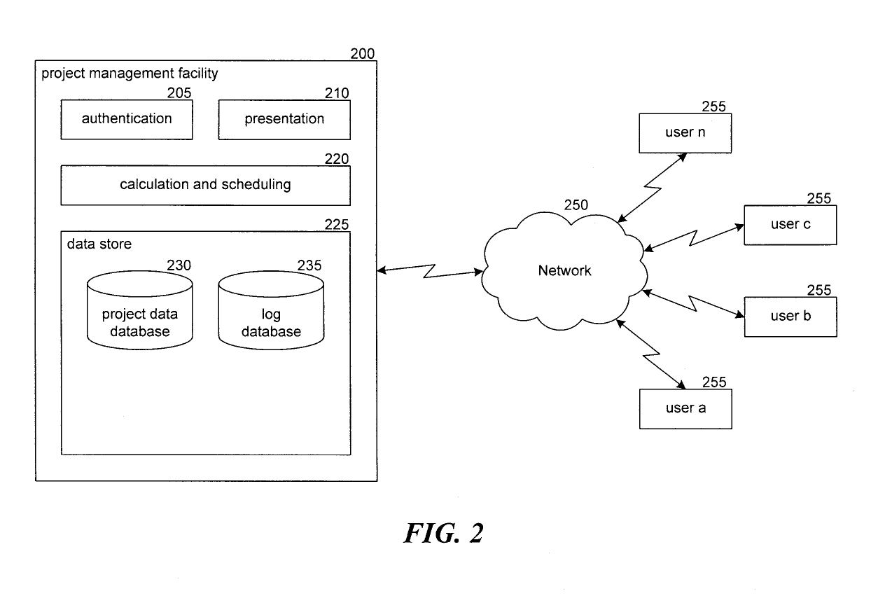

FIG. 2 is a block diagram illustrating components of a project management facility 200 (“the facility”). Users 255 interact with the facility via a network 250, such as the Internet. Users may be actual human users, such as members of a project or organization, computer programs, or other entities. The facility allows users to build and manage project schedules having uncertainty in tasks associated with the project. The facility has various components to allow users to manage projects. These components include an authentication component 205, a presentation component 210, a calculation and scheduling component 220 and a data store 225. The authentication component 205 authenticates the user 255 and grants the user 255 access to the facility. The presentation component 210 presents a user interface to the user 255 and receives user requests and responses. The calculation and scheduling component 220 performs statistical calculations to predict likely completion dates for project tasks and projects and calculate likely project schedules. The facility can include other components that perform other functions. The various components of the facility can retrieve and store data related to their functioning in the data store 225, which includes a project data database 230 and a log database 235.

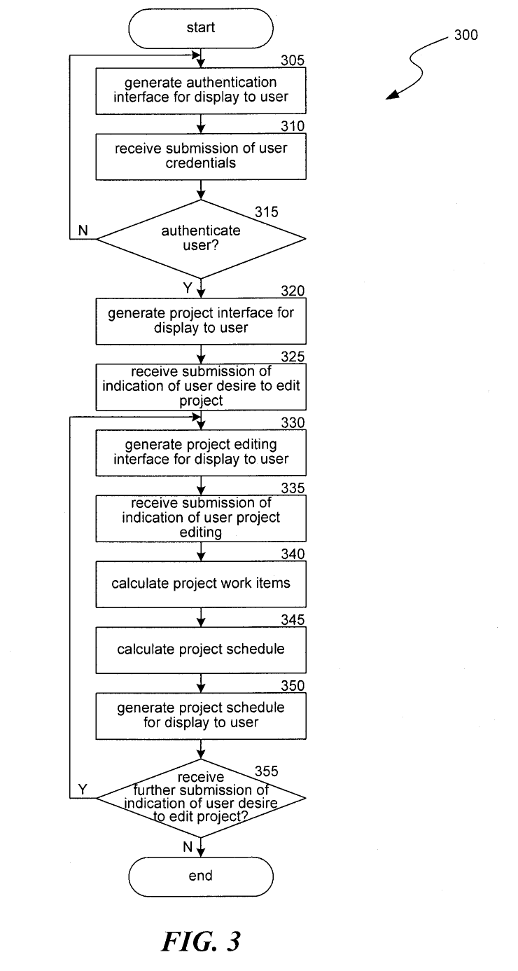

FIG. 3 is a flow diagram of a process 300 implemented by the facility to allow a user to edit a project and to calculate the project's schedule based on data entered by the user. At block 305 the facility generates an authentication interface for display to a user. Those skilled in the art will appreciate that the user can be authenticated in a variety of ways, such as a username and password combination, a digital certificate, or a biometric identifier. At block 310 the facility receives the submission of credentials from the user. The facility determines whether the user credentials are valid at block 315. If they are not valid, the process 300 returns to block 305 where the authentication interface is again generated for display to the user. If the user credentials are valid the process 300 continues at block 320 where the facility generates a project management interface for display to the user.

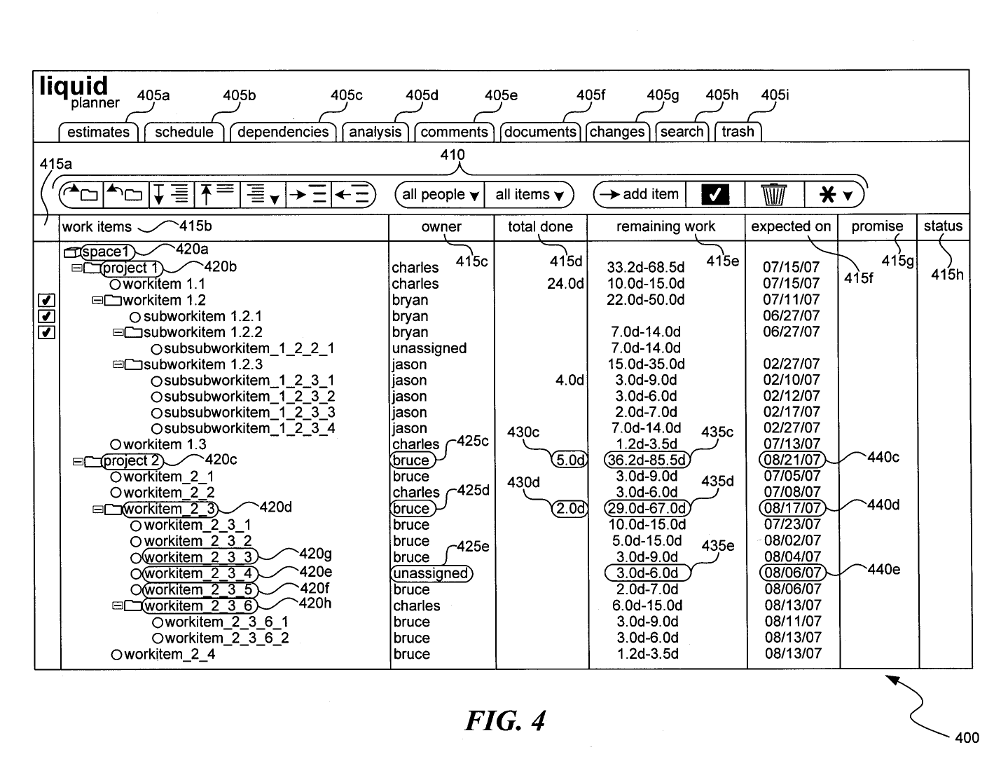

FIG. 4 is a block diagram of a representative project management interface 400 that the facility may generate. The project management interface 400 allows a user to view, create, modify, administer and/or delete projects, project tasks and various attributes thereof. The project management interface 400 has several tabs 405a, 405b, . . . 405i for displaying various project management aspects. As illustrated the tab 405a, labeled “estimates,” is currently active. The project management interface 400 can also have various controls 410 that enable viewing, creating, modifying, administering and/or deleting projects, project tasks and various attributes thereof. The project management interface 400 includes various columns that can each represent one or more aspects of project management. For example, column 415b contains a listing of work items, arranged in a hierarchical structure. Work items can include spaces, such as space 420a. A space can be used to represent a user's work space, such as all the projects in which the user is involved. Work items can also include projects, such as projects 420b and 420c. Projects can represent a project or other effort by zero or more users. Projects can include one or more containers, such as container 420d and container 420h. Containers can represent logical groupings or collections of zero or more tasks and/or containers. Containers can include tasks and/or other containers, such as tasks 420e, 420f and 420g and container 420h. A task can represent an actual task, job or assignment by zero or more users. Work items can also include logical representations of other aspects of project management that are not shown in FIG. 4.

Each of the various work items (space, project, container, or task) can have various attributes associated with it. The project management interface 400 displays certain of these attributes in the other columns. Column 415a can display a visually informative icon or flag associated with a work item. Such icon may represent, for example, when the associated work item is complete. Each work item can have zero or more owners, which are displayed in column 415c. For example, work items 420c and 420d have as an owner elements 425c and 425d, respectively, both of which are “bruce.” Work item 420e does not currently have an owner, shown as element 425e, which is “unassigned.” A work item can also have associated with it a “total done” attribute representing a quantity of work performed on the work item. This attribute is shown in the “total done” column 415d, which includes “total done” amounts 430c and 430d, which are “5.0d” and “2.0d,” respectively. A work item can also have associated with it a “remaining work” attribute representing a quantity of work remaining to be performed on the work item. This attribute is shown in column 415e. “Remaining work” can be expressed as a range, such as “36.2d-85.5d,” “29.0d-67.0d” and “3.0d-6.0d,” as depicted in elements 435c, 435d and 435e. “Remaining work” can also be expressed as a single time period, such as “5.0d,” as a series of time periods with a confidence level of each period, such as “10% in 5.0d, 70% in 6.0d, or 20% in 7.0d,” as a total amount of work and percentage or work remaining (e.g., 40% of 7 total days of effort remaining), or in a variety of other ways. Both “total done” and “remaining work” attributes are shown expressed in days (i.e., “5.0d” equals “5.0 days”). However, these and other attributes can be expressed in other time periods, including seconds, minutes, hours, weeks, months and/or years. The project management interface 400 can display “remaining work” as anticipatory (i.e., the work remaining to be done in the future from this point forward), or as calculated from a particular point in time.

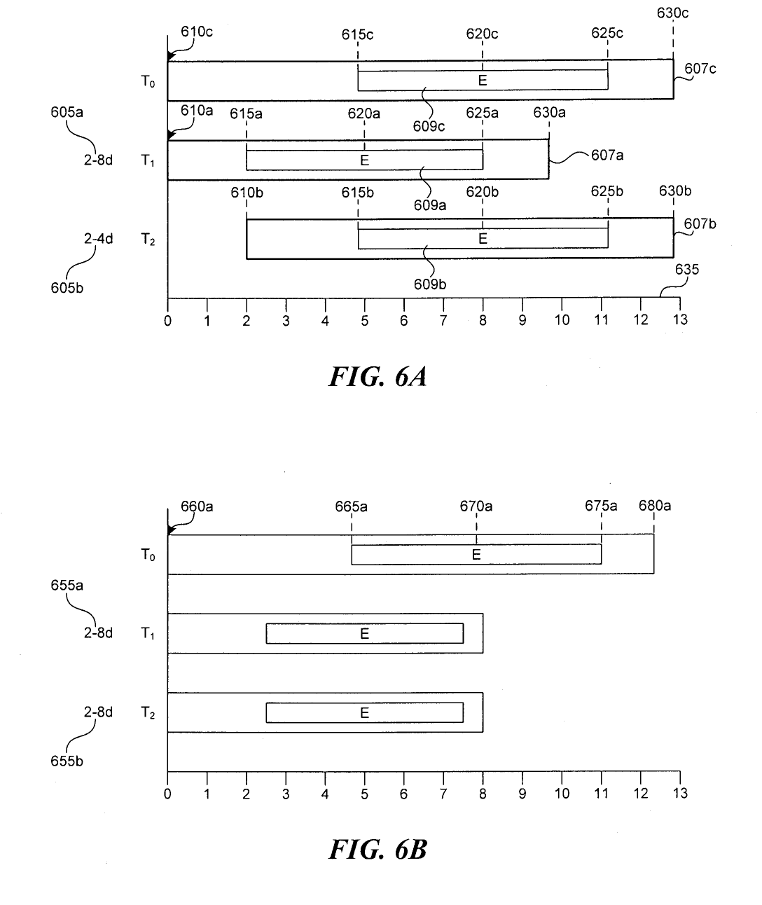

The project management interface 400 displays in column 415f an “expected on” attribute, which corresponds to the calculated expected finish date for a work item. For example, work item 420c has an “expected on” date 440c of “Aug. 21, 2007.” Similarly, work item 420d has an “expected on” date 440d of “Aug. 17, 2007” and work item 420e has an “expected on” date 440e of “Aug. 6, 2007.” For some projects, the “expected on” date may include a time of completion (e.g., 5 pm) in addition to a date. The calculation of a work item's “expected on” date will be discussed with reference to FIGS. 6A and 6B and elsewhere herein. The project management interface 400 displays attributes corresponding to a work item's promise date and status in columns 415g and 415h. The promise date can be a date by which the user has promised or agreed that the work item will be done. The status can be an indication of the current status, condition or standing of the work item according to a project metric or other standard.

In some embodiments, instead of allowing users to specify a “work remaining” range for a work item in terms of units of time, the facility can allow users to specify estimates in other formats. These can include a range of an amount of money, budget percentages, total effort, and/or other work item inputs. For example, the facility can allow a user to specify that the completion of a work item is likely to cost from about $2,000 to about $5,000. As another example, the facility can allow a user to specify that the amount of effort required to complete work item is equal to six on a scale of one to ten. The facility can also allow a user to specify an express confidence level or confidence factor when providing a ranged estimate. For example, the facility can allow a user to specify that the user is 20% confident of being able to complete a work item in two days, and 90% confident of being able to complete a work item in four days. The facility can also allow a user to specify an estimate for one work item in one format and an estimate for a second work item in a different format. These examples are not limiting and those of skill in the art will understand that the facility can allow users to provide estimates in a variety of formats.

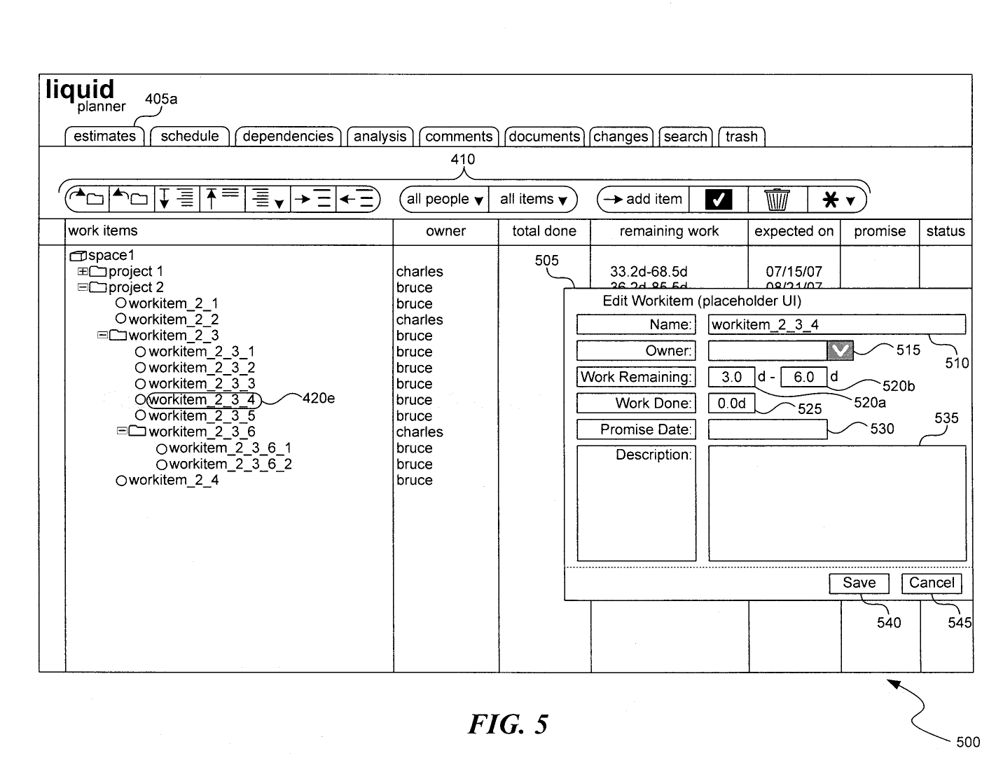

Returning to FIG. 3, at block 325 the facility receives a submission indicating a desire of the user to edit the project in some way. Editing can refer to a variety of actions by the user, including, but not limited to, viewing a work item in greater detail, creating a new work item, modifying an aspect of a work item or deleting a work item. At block 330 the facility generates a project editing interface for display to the user. FIG. 5 is a representative screenshot depicting an interface 500 for editing a work item, which can include a modal or modeless window 505. As depicted, the facility has displayed the window 505 in response to the submission of an indication of the user's desire to edit work item 420e. The window 505 allows the user to edit various aspects of work item 420e. In text box 510 the user can modify the name of the work item. The user can modify the owner of a work item via combo box 515, which can include a listing of users involved in the project, in an organization, or in a particular group. As displayed, the work remaining for a work item can be modified by changing the low end 520a and the high end 520b of a range of time. The quantity of work done for a work item can also be modified in text box 525. A promise date can be modified in text box 530 and a description of the work item can be modified in text box 535. A user can save the edits by clicking on button 540 or cancel the edits by clicking on button 545.

Returning again to FIG. 3, at block 335 the facility receives a submission of an edit of the project from the user, such as by the user's clicking on button 540 of FIG. 5. At block 340 the facility performs statistical calculations for any work items that have been edited as well as any dependent work items.

FIGS. 6A and 6B illustrate work item task effort and project schedule calculation performed by the facility. FIG. 6A depicts three work items T₀, T₁ and T₂. In this display, T₁ can represent a task, T₂ can represent a second task, and T₀ can represent a container, such as a project, under which tasks T₁ and T₂ are located. T₂ is dependent upon T₁, i.e., T₂ cannot be started before T₁ is completed. T₁ has a range 605a of “2-8d” associated with it that corresponds to a ranged estimate of two to eight days of work remaining to be done on the work item. T₂ has a range 605b of “2-4d” that corresponds to a ranged estimate of two to four days of work remaining to be done on the work item.

Each of work items T₀, T₁, and T₂ is graphically represented by an outer bar and an inner bar, collectively called a u-bar. For example, work item T₁ is represented by outer bar 607a that contains inner bar 609a. Each work item has five points representing start or finish dates associated with it. In the case of T₁, the first point 610a is located at the left-most position of the outer bar 607a and represents the earliest start date of the work item. The second point 615a is located at the left-most position of the inner bar 609a and represents the earliest expected finish date of the work item. The third point 620a is located at an intermediate section of the inner bar 609a and represents the expected finish date of the work item. The fourth point 625a is located at the right-most position of the inner bar 609a and represents the latest expected finish date of the work item. The fifth point 630a is located at the right-most position of the outer bar 609a and represents the latest finish date of the work item. Similarly, T₂ has five points 610b, 615b, 620b, 625b, and 630b representing start and finish dates associated with it, as does T₀: 610c, 615c, 620c, 625c and 630c.

The work items T₀, T₁ and T₂ may be placed on a timeline 635 representing elapsed time since the start of the project. Work item T₁ is the first work item and has no dependencies, so the first point 610a is located at the beginning of day 1. This is because the beginning of day 1 is the earliest possible start of T₁. The facility determines the location of the second 615a, third 620a, fourth 625a and fifth 630a data points for T₁ in accordance with values predicted by a statistical model. In some embodiments, the statistical model used by the facility is a normal distribution. Beginning with the third data point 620a, which can be shown by a capital “E” to represent the expected finish, it is located at the midpoint of the remaining work range for T₁. This is because the midpoint of the remaining work range for T₁ is the mean of a normal distribution. For T₁, the remaining work range 605a is “2-8d,” the midpoint of which is 5d, and thus the third data point 620a is placed at the end of day 5. The expected finish date calculated by the facility is what is shown in the “expected on” column 415f discussed with reference to FIG. 4. In some embodiments, the facility can use distributions other than the normal distribution to calculate the locations of the various data points. For example, the facility can use a beta distribution or a log-normal distribution to calculate the locations of the various data points. The facility can also use distributions that do not resemble a standard bell curve, are bi-modal instead of uni-modal and/or have other characteristics. The facility can also use different distributions for different work items. For example, the facility can use the normal distribution for one work item and the beta distribution for another work item. The facility can use points other than the midpoint of the remaining work range to calculate the expected finish, such as any point in the remaining work range or even points outside of the remaining work range, depending on various factors. The facility can also use other characteristics of the distribution used, such as the median or the mode, to calculate the expected finish. The facility can also learn from its users to adjust the distribution used to better reflect how its users perform tasks. For example, a user may repeatedly specify that a particular task has a remaining work range of four to eight days. However, the user may repeatedly require seven days to complete the task. In that case, the facility may adjust the normal distribution for that user and/or for that particular task in order to calculate an expected finish date and other dates that better reflect how the user actually completes the task.

The facility calculates the locations of the second 615a and fourth 625a data points for T₁ according to the following method. First, a desired confidence level is determined for T₁. A confidence level, or confidence interval, represents the likelihood or probability that a particular work item will be completed during the period of time between the earliest expected finish date and the latest expected finish date. In some embodiments, the facility uses an 80% confidence level, which corresponds to 1.3 standard deviations from the mean of the normal distribution. An 80% confidence level thus represents an 80% likelihood or probability that a particular work item will be completed during the time period represented by 1.3 standard deviations on either side of the mean. Other confidence levels may be selected depending on the requirements of the facility operator or the user.

Second, the facility calculates the standard deviation in the work remaining range for T₁. The standard deviation in the work remaining range is calculated according to the following equation:

$${σ}_{E} = \frac{H - L}{2 \times C} \qquad ( 1 )$$

In equation (1), H represents the upper limit of the work remaining range, L represents the lower limit of the work remaining range, and C represents the desired confidence level (when expressed as a standard deviation). The standard deviation in the work remaining range for a work item can be reduced by specifying a narrower work remaining range. For example, a work remaining range of “two to four days” will have a smaller standard deviation than a work remaining range of “two to eight days.”

For T₁, the upper limit of the work remaining range is 8 days and the lower limit of the work remaining range is 2 days, and for an 80% confidence level, C is 1.3. Therefore, the standard deviation in the work remaining range for T₁ is calculated as:

$${σ}_{{E}_{1}} = \frac{8 - 2}{2 \times 1.3} = 2.31 \qquad ( 2 )$$

Third, the facility calculates the standard deviation in the schedule for T₁. Because T₁ is the first work item, this is done by taking the square root of the square of the standard deviation in the work remaining range for T₁. More generally, however, the standard deviation in the schedule for a work item is calculated according to the following equation:

σ_{S}_{ₙ}=\sqrt{σ_{S}_{ₙ₋₁}²+σ_{E}_{ₙ}²} (3)

For the first work item T₁, n=1 and σ_{S}_{ₙ₋₁}² resolves to 0, therefore the standard deviation in the schedule for T₁ is:

σ_{S}_{₁}=\sqrt{0+2.31²}=2.31 (4)

Therefore, the standard deviation in the schedule for T₁, is also 2.31.

Fourth, the facility multiplies the standard deviation in the schedule for T₁ by the same constant C that represents the desired confidence level to calculate the locations of the second 615a and fourth 625a data points. Thus these locations, corresponding to an 80% confidence level, are given by:

σ_{S}_{ₙ}×C=2.31×1.3=3.0 (5)

Therefore the second data point 615a, or earliest expected finish is located 3.0 days before the expected finish, at the end of day 2, and the fourth data point 625a, or latest expected finish, is located 3.0 days after the expected finish, at the end of day 8. The second data point 615a represents a 10% likelihood that the work item T₁ will be completed by that particular point in time. The fourth data point 625a represents a 90% likelihood that the work item T₁ will be completed by that particular point in time. Instead of using an 80% confidence level, the facility can use a different confidence level, such as one that is asymmetrical about the mean of the normal distribution or has a different value (e.g., a 55% confidence level). The location of the fifth data point 630a is calculated by determining, according to the normal distribution, the point at which there is a 98% likelihood of the work item T₁ being completed. This can be calculated by multiplying the standard deviation in the schedule by the appropriate constant. However, it is to be understood that the facility can use other percentage likelihoods to determine the location of the fifth data point 630a.

Once the various data points are calculated for work item T₁, work item T₂ may be placed on the timeline. For T₂, the location of the third data point 620b (the expected finish point) is determined by taking the remaining work range for T₂, 2-4d, calculating the midpoint, 3d, and adding the midpoint to the expected finish date of T₁, which is at the end of day 5. Therefore the location of the third data point 620b for T₂ is at the end of day 8. The locations of the first 610b, second 615b, fourth 625b and fifth 630b data points for T₂ are calculated in the same fashion that the locations of the corresponding data points for T₁ are calculated, with one exception. Because T₂ cannot be started until T₁ is completed, the location of the first data point 610b for T₂ is calculated by determining the earliest possible start date for T₂. This is at the end of day 2, as this is the earliest possible end date for T₁.

The standard deviation in the work remaining range for T₂ is thus calculated as:

$${σ}_{{E}_{2}} = \frac{4 - 2}{2 \times 1.3} = 0.77 \qquad ( 6 )$$

The standard deviation in the schedule for T₂ is thus calculated as:

σ_{S}_{₂}=\sqrt{σ_{S}_{₂}²+σ_{E}_{₂}²}=\sqrt{2.31²+0.77²}=2.43 (7)

The facility multiplies the standard deviation in the schedule for T₂ by the constant C that represents the desired confidence level for T₂, giving a value of 3.16. Thus the facility calculates that the locations of the second 615b and fourth 625b data points are 3.16 days from the location of the third data point 620b, or at 4.8 days and 8.2 days, respectively. The location of the fifth data point 630b for T₂ is calculated by determining, according to the normal distribution, the point at which there is a 98% likelihood of the work item T₂ being completed. This can be calculated by multiplying the standard deviation in the schedule by the appropriate constant. Work item T₂ may then be displayed on the timeline in an appropriate relationship with respect to work item T₁.

In some embodiments, the facility can use different confidence levels for work items. For example, the facility can use an 80% confidence level for one work item and a different confidence level, such as a 60% confidence level, for another work item. A smaller confidence level results in a narrower inner bar 609. For example, an 80% confidence level has a wider inner bar 609 than a 50% confidence level has. The confidence level may be selected by a user based on the particular type of work associated with a work item.

It is to be noted that although T₂ does not have a large standard deviation in its work remaining range due to its narrowness (2-4d), the uncertainty bar for T₂ nonetheless displays a relatively large amount of uncertainty as to its expected finish dates. This is because the completion of T₂ is dependent upon the completion of T₁, for which a large amount of uncertainty as to its expected finish dates exists due to the width of its work remaining range (2-8d). In other words, the uncertainty in T₁ affects the uncertainty in T₂.

As previously noted, T₀ can represent a container, such as a project, under which tasks T₁ and T₂ are located. T₀ also has five data points associated with it: 610c, 615c, 620c, 625c and 630c, that represent the earliest start date, the earliest expected finish date, the expected finish date, the latest expected finish date and the latest finish date, respectively. The location of the first data point, 610c, is at the beginning of day 1, because the beginning of day 1 is the earliest possible start of the tasks under T₀. The facility places the location of the second 615c, third 620c, fourth 625c and fifth 630c data points in the same locations as the second 615b, third 620b, fourth 625b and fifth 630b data points for T₂. The facility does so because T₂ is the last work item under T₀. Therefore the earliest expected finish date, the expected finish date, the latest expected finish date and the latest finish date for T₂ will be the earliest expected finish date, the expected finish date, the latest expected finish date and the latest finish date for T₀, respectively.

Although for purposes of illustration, FIG. 6A only depicts two work items under work item T₀, any number of work items can be placed under work item T₀. The facility can thus calculate the various dates for all the work items under T₀ and generate uncertainty bars that display these various dates.

Similar to FIG. 6A, FIG. 6B depicts three work items: T₀, T₁ and T₂, and u-bars for each of the work items. In this display, T₁ can represent a task, T₂ can represent a second task, and T₀ can represent a container, such as a project, under which tasks T₁ and T₂ are located. In FIG. 6B, work items T₁ and T₂ are independent, i.e., one work item does not depend upon the completion of another before it can be started. T₁ has a range 655a of “2-8d” associated with it that corresponds to the remaining work to be done and T₂ similarly has a range 655b of remaining work of “2-8d.” Each of work items T₁, T₂ has five data points associated with it, as reflected graphically by the u-bars. T₀ has five data points associated with it: 660a, 665a, 670a, 675a and 680a, that represent the earliest start date, the earliest expected finish date, the expected finish date, the latest expected finish date and the latest finish date, respectively.

As previously noted, the expected finish dates of work items T₁, T₂ can be modeled by a normal distribution. Therefore, each of work items T₁, T₂ has an associated probability density function that reflects the probability of when each work item should be finished. The probability of a work item being completed at a particular point in time t can be determined by integrating the probability density function associated with the work item, as shown by the following equation:

$$P ( t ) = {\int }_{- ∞}^{t} P ( x ) d x \qquad ( 8 )$$

In equation (8), P(x) is the associated probability density function (e.g., for a normal distribution) and P(t) is the probability of the work item being completed at a time t. The probability of work items T₁, T₂ being completed can thus be determined at any particular point in time in accordance with equation (8).

For work item T₀, the probability of it being completed at a particular point in time can be calculated according to the following equation:

$$P ( T ) = {\int }_{0}^{T} {P}_{1} ( t ) \cdot {P}_{2} ( t ) d t \qquad ( 9 )$$

In equation (9), P₁(t) is the probability density function associated with T₁ and P₂(t) is the probability function associated with T₂. The probability of work item T₀ being completed at a particular point in time T is thus given by integrating the product of the probability density functions for T₁ and T₂ from 0 to T. The facility thus is able to calculate the locations of the first 660a, second 665a, third 670a, fourth 675a and fifth 680a data points for T₀. The first data point 660a corresponds to the beginning of day 1 (because the beginning of day 1 is the earliest start date for either of work items T₁ and T₂); the second data point 665a corresponds to the 10% likelihood of both work items T₁ and T₂ being completed; the third data point 670a corresponds to the 50% likelihood of both work items T₁ and T₂ being completed; the fourth data point 675a corresponds to the 90% likelihood of both work items T₁ and T₂ being completed; and the fifth data point 680a corresponds to the 98% likelihood of both work items T₁ and T₂ being completed. As reflected in FIG. 6B, the expected finish date for the overall project T₀ occurs after the expected finish dates for the work items T₁ and T₂. Such a result is not intuitive for most project managers that manage work items in parallel.

Although for purposes of illustration, FIG. 6B only depicts two work items under work item T₀, any number of work items can be placed under work item T₀. The facility can thus calculate the various dates for all the work items under T₀ and generate uncertainty bars that display these various dates.

As previously noted, the facility can use distributions other than the normal distribution, varying confidence levels, and/or varying probability density functions to determine expected start and finish dates. The facility can thus calculate statistically likely start and finish dates for work items, including spaces, projects, containers, and tasks. In so doing, the facility accounts for the uncertainty inherent in tasks. This allows the facility to account for the uncertainty inherent in the project to which tasks belong.

In some embodiments, instead of calculating dates for a work item, the facility can calculate amounts of remaining effort for a work item, based at least in part on the user-provided estimate. For example, the user can provide an estimate as to the effort remaining for a work item, such as “5 to 10 days.” The facility can use this estimate to calculate four amounts of remaining effort. The first amount is the expected minimum remaining effort and corresponds to the earliest expected finish date. The second amount is the expected remaining effort and corresponds to the expected finish date. The third amount is the maximum expected remaining effort and corresponds to the latest expected finish date. The fourth amount is the maximum remaining effort and corresponds to the latest finish date. The facility can then display the uncertainty in remaining effort for the work item in a u-bar that has five points to represent the earliest start and the four amounts of remaining effort.

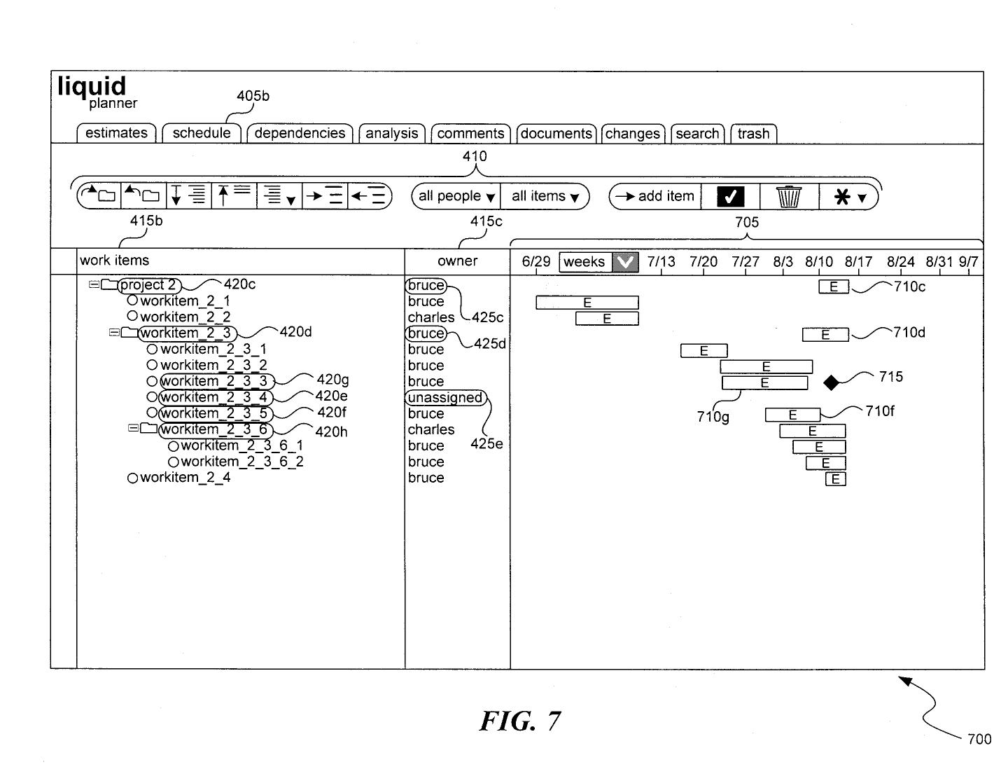

Again returning to FIG. 3, at block 345 the facility calculates a project schedule and at block 350 the facility generates an updated project schedule for display to the user. FIG. 7 is a representative screenshot depicting another project management interface 700 that the facility may generate for display to a user. The project management interface 700 includes a project schedule column 705. As previously discussed with reference to FIG. 4, the work items column 415b contains various work items, including work item 420c, which is a project, work item 420d, which is a container, and work items 420e, 420f and 420g, all of which are tasks. Each of the work items 420 in the work items column 415b can have a corresponding u-bar 710 in the project schedule column 705. For example, u-bar 710f corresponds to work item 420f; u-bar 710d corresponds to work item 420d, and u-bar 710c corresponds to work item 420c. The facility has not generated a u-bar for work item 420e. This may occur if no user owns work item 420e, or if the owner has not specified a work remaining range for work item 420e. In such instances, the facility may notify appropriate users, such as by sending an email notification to a project manager or other user, that the work item lacks an owner or a work remaining range.

Each u-bar 710 in the project schedule column 705 displays the earliest start date, earliest expected finish date, expected finish date, latest expected finish date and the latest finish date as calculated by the facility for the corresponding work item 420. The facility can use the techniques described with references to FIGS. 6A and 6B to generate the u-bars 710. In generating u-bars, the facility begins at the top-most work item in the work items column 415b and traverses downward until it has reached a work item that represents a task. The facility then calculates the expected start and finish dates for that work item. The facility then proceeds to the next work item that represents a task that is within the same container and calculates its expected start and finish dates. If the tasks are dependent, the facility groups the tasks and treats them as if they were a single independent task for purposes of calculating the u-bars for parent work items. The facility traverses downward through the work items column 415b and calculates the expected start and finish dates for each task and groups dependent tasks until it has traversed to the bottom of the work items column 415b. The facility then calculates the expected start and finish dates for the work items that are parents of the task work items (e.g., containers, projects and spaces), beginning at the bottom of the work items column 415b and proceeding upwards until it has reached the top-most work item. The facility generates u-bars for each parent work item. The u-bar for the top-most work item represents the earliest start date, earliest expected finish date, expected finish date, latest expected finish date and the latest finish date for the top-most work item and all work items that are contained within it or are children of it. In the interface 700 depicted, work item 420c is the top-most work item and represents a project. Corresponding u-bar 710c represents the earliest start date, earliest expected finish date, expected finish date, latest expected finish date and the latest finish date for all work items within the work item 420c, i.e., all work items in the entire project. It is to be understood that the facility may calculate the dates and generate the u-bars according to other algorithms, such as by beginning at the bottom-most work item and traversing upwards.

The project schedule region 705 also includes a marker 715, shown as a diamond icon, that illustrates the use of a promise date for a work item. Referring back to FIG. 5, a user can enter a promise date when adding or modifying a work item. A promise date can be a date by which the user has promised or agreed that the work item will be done. As depicted, a user has set a promise date for work item 420g. The marker 715 lies outside of the u-bar 710g that corresponds to work item 420g. This indicates that as calculated by the facility, work item 420g is nearly certain (a probability of at least 98%) to be completed by the promise date indicated by marker 715. The use of promise dates in conjunction with the graphical schedule region may be used by project managers to assess the likelihood that a user making a promise will be able to meet that promise.

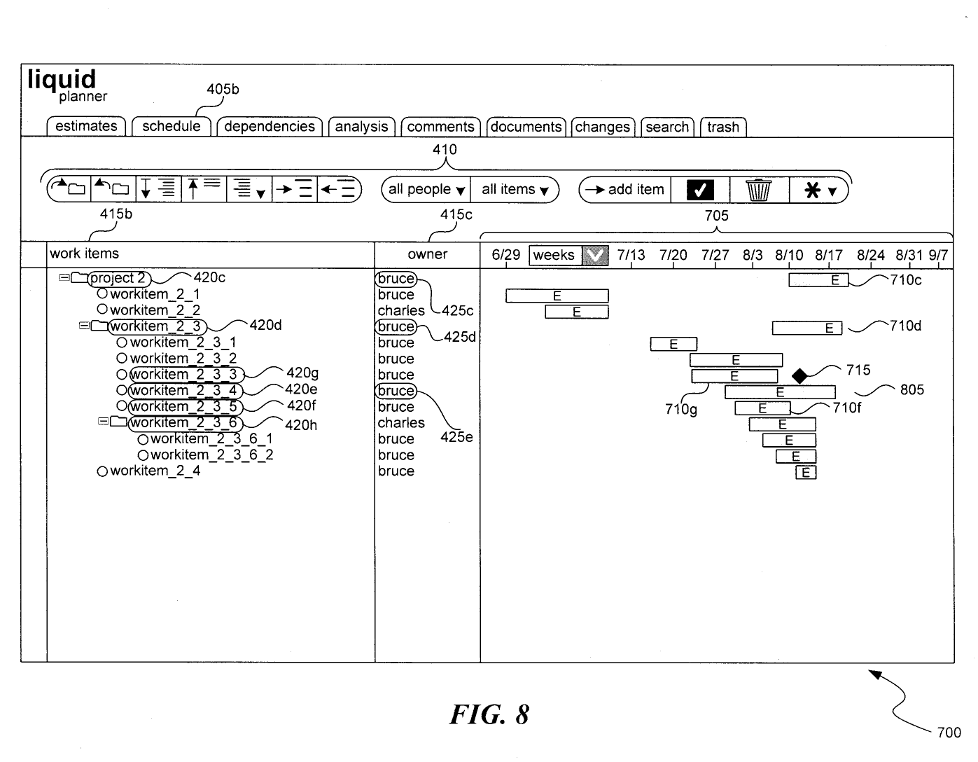

Returning again to FIG. 3, after having generated a revised project schedule for display to the user at block 350, the process continues at block 355 where the facility determines whether the facility received further submissions of a user's desire to edit the project. If so, the process returns to block 330. FIG. 8 depicts the interface of FIG. 7 illustrating the effect of a revised project schedule after a project edit. As illustrated, the work item 420e has been edited to reflect the assigned owner, shown as element 425e, which is “bruce.” The work item 420e also has been edited to add a work remaining range (not shown). The facility has generated a u-bar 805 for work item 420e. The effect of the edit has been to extend u-bars 710c and 710d, which correspond to work items of which the work item 420e is an immediate or distant child. This is because adding the work remaining range for work item 420e affects the expected start and finish dates for work items 410c and 410d. The u-bars of other work items, such as work items that are dependent upon work item 420e, may also be similarly extended as the expected start and finish dates of these work items may have changed. The expected start and finish dates for work items owned by a user can also change when a new work item is assigned to that user, which can change the user's workload, or when a work item is removed from that user's responsibility, which can also change the user's workload.

In some embodiments, if the facility does not receive updates from users regarding the amount of work remaining for work items, the facility can assume that work is being performed on the work items and calculate remaining work associated with the work item accordingly. For example, if a user specifies that the work remaining range for a work item is two to four days, the facility may assume that at the completion of day two, two days of work have been performed on the work item. In some embodiments, however, the facility may expressly require that users provide updated estimates regarding the work remaining to be done on work items.

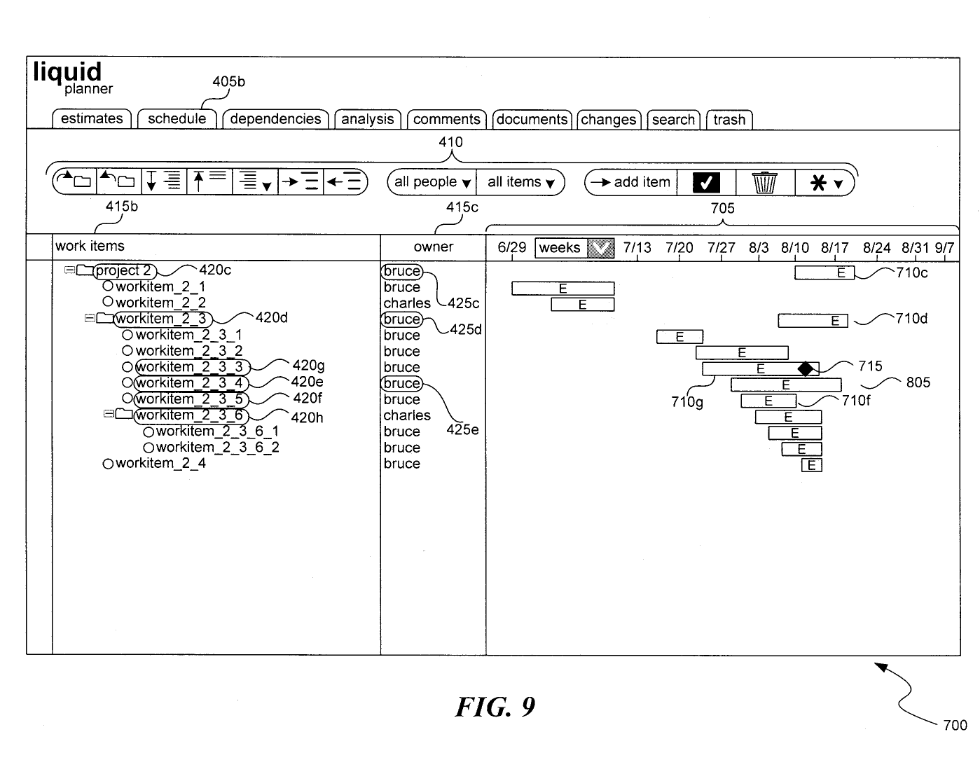

FIG. 9 depicts the interface of FIG. 7 illustrating the effect of an edit to the work remaining range of a work item that could potentially cause the work item to miss its promise date. As illustrated, the work remaining range of work item 420g has been edited. The facility has re-estimated at least the earliest expected finish date, expected finish date, latest expected finish date and latest finish date for work item 420g, and generated a revised u-bar 710g to reflect the changed estimates. As illustrated, the work item 420g has a later latest finish date, which extends the corresponding u-bar 710g rightwards (i.e., forward in time). U-bar 710g now overlaps marker 715, which represents the promise date for work item 420g. The facility can thus visually inform a user that there is a significant likelihood or probability that work item 420g will not be completed by its promise date. The facility may do so by highlighting or changing the color of work item 420g and/or its u-bar 710g. The facility may also take steps to notify appropriate users, such as by sending an email notification to work item owners or project managers, that a work item may not be completed by its promise date.

Again returning to FIG. 3, if the facility determines that the user does not further desire to edit the project, the process 300 ends.

While various embodiments are described in terms of the environment described above, those skilled in the art will appreciate that various changes to the facility may be made without departing from the scope of the invention. For example, project data database 130 and log database 135 are indicated as being contained in a general data store 125. Those skilled in the art will appreciate that the actual implementation of the data store 125 may take a variety of forms, and the term “database” is used herein in the generic sense to refer to any data structure that allows data to be stored and accessed, such as tables, linked lists, arrays, etc.

Those skilled in the art will also appreciate that the facility may be implemented in a variety of environments including a single, monolithic computer system, a distributed system, as well as various other combinations of computer systems or similar devices connected in various ways. Moreover, the facility may utilize third-party services and data to implement all or portions of the information functionality. Those skilled in the art will further appreciate that the steps shown in FIG. 3 may be altered in a variety of ways. For example, the order of the steps may be rearranged, substeps may be performed in parallel, steps may be omitted, or other steps may be included.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A method of calculating a schedule for a project comprised of a plurality of tasks, the method comprising:
receiving from a user a definition for at least some of a plurality of tasks comprising a project, the received definition for a task comprising a task identifier, a relationship to at least one other of the plurality of tasks, and a range of work associated with the task;
applying a statistical model to estimate an expected task completion date for each of the plurality of tasks having a definition, wherein the statistical model is applied to the range of work associated with a task and the expected task completion date reflects a date by which the associated task will likely be completed; and
utilizing the expected task completion date for each of the plurality of tasks having a definition to calculate a schedule for the project.

2. The method of claim 1, wherein the statistical model is a normal distribution.

3. The method of claim 2, wherein the normal distribution has a mean and the calculation of the expected task completion date is based at least in part on the mean of the normal distribution.

4. The method of claim 1, further comprising calculating an earliest expected finish and a latest expected finish for each of the plurality of tasks using the statistical model.

5. The method of claim 4 wherein the earliest expected finish and the latest expected finish represent an 80% confidence level.

6. The method of claim 4, wherein the statistical model is a normal distribution and the calculation of the earliest expected finish and the latest expected finish is based at least in part on values given by 1.3 standard deviations from the mean of the normal distribution.

7. The method of claim 1, wherein the range of work is specified by an amount of time estimated to complete the task.

8. The method of claim 1, wherein the range of work is specified by an amount of money estimated to complete the task.

9. The method of claim 1, wherein the range of work is specified by an indication of effort estimated to complete the task.

10. The method of claim 1, wherein the range of work further includes a confidence factor.

11. The method of claim 1, further comprising calculating an expected finish for the project, wherein the expected finish for the project depends at least in part on the expected task completion dates of the plurality of tasks comprising the project.

12. The method of claim 1, further comprising:
receiving an updated range of work from the user regarding a task; and
applying the statistical model to estimate the expected task completion date for the task based on the updated range of work.

13. The method of claim 12, further comprising using the updated estimate of the expected task completion date to revise the schedule for the project.

14. The method of claim 1, wherein a relationship between two tasks is the tasks are performed in parallel.

15. The method of claim 1, wherein a relationship between two tasks is the tasks are performed in series.

16. The method of claim 1, wherein a relationship between two tasks is determined by a time associated with each task.

17. The method of claim 1, wherein a relationship between two tasks is determined by an order associated with each task.

18. The method of claim 1, wherein at least two of the plurality of tasks are assigned to an individual, and a relationship between the two tasks is determined by the workload of the individual.

19. The method of claim 1, wherein the range of work includes a low estimate and a high estimate of the work associated with the task.

20. The method of claim 1, wherein the statistical model is one of a normal distribution, a beta distribution, or a log-normal distribution.

21. The method of claim 20, wherein different statistical models are applied to estimate an expected task completion date for at least two of the plurality of tasks having a definition.

22. A system for managing a schedule of a project comprised of a plurality of tasks, the system comprising:
in input module for receiving from a user a definition for at least some of a plurality of tasks comprising a project, the received definition for a task comprising a task identifier, a relationship to at least one other of the plurality of tasks, and a range of work associated with the task;
a task estimation module for applying a statistical model to estimate an expected task completion date for each of the plurality of tasks having a definition, wherein the statistical model is applied to the range of work associated with a task and the expected task completion date reflects a date by which the associated task will likely be completed;
a project estimation module for utilizing the expected task completion date for each of the plurality of tasks having a definition to calculate a schedule for the project; and
a presentation module for displaying the schedule for the project to the user in a manner that depicts at least some of the relationships between the plurality of tasks comprising the project.

23. The system of claim 22, wherein the statistical model is a normal distribution.

24. The system of claim 23, wherein the normal distribution has a mean and the calculation of the expected task completion date is based at least in part on the mean of the normal distribution.

25. The system of claim 22, wherein the task estimation module further calculates an earliest expected finish and a latest expected finish for each of the plurality of tasks using the statistical model.

26. The system of claim 25 wherein the earliest expected finish and the latest expected finish represent an 80% confidence level.

27. The system of claim 25, wherein the statistical model is a normal distribution and the calculation of the earliest expected finish and the latest expected finish is based at least in part on values given by 1.3 standard deviations from the mean of the normal distribution.

28. The system of claim 22, wherein the range of work is specified by an amount of time estimated to complete the task.

29. The system of claim 22, wherein the range of work is specified by an amount of money estimated to complete the task.

30. The system of claim 22, wherein the range of work is specified by an indication of effort estimated to complete the task.

31. The system of claim 22, wherein the range of work further includes a confidence factor.

32. The system of claim 22, wherein the project estimation module further calculates an expected finish for the project, wherein the expected finish for the project depends at least in part on the expected task completion dates of the plurality of tasks comprising the project.

33. The system of claim 22, wherein the input module receives an updated range of work from the user regarding a task, and the task estimation module applies the statistical model to estimate the expected task completion date for the task based on the updated range of work.

34. The system of claim 33, wherein the project estimation module uses the updated estimate of the expected task completion date to revise the schedule for the project.

35. The system of claim 22, wherein a relationship between two tasks is the tasks are performed in parallel.

36. The system of claim 22, wherein a relationship between two tasks is the tasks are performed in series.

37. The system of claim 22, wherein a relationship between two tasks is determined by a time associated with each task.

38. The system of claim 22, wherein a relationship between two tasks is determined by an order associated with each task.

39. The system of claim 22, wherein at least two of the plurality of tasks are assigned to an individual, and a relationship between the two tasks is determined by the workload of the individual.

40. The system of claim 22, wherein the range of work includes a low estimate and a high estimate of the work associated with the task.

41. The system of claim 22, wherein the statistical model is one of a normal distribution, a beta distribution, or a log-normal distribution.

42. The method of claim 22, wherein different statistical models are applied to estimate an expected task completion date for at least two of the plurality of tasks having a definition.

43. A computer-readable medium whose contents cause a computing system to perform a method of calculating a schedule for a project comprised of a plurality of tasks, the method comprising:
receiving from a user a definition for at least some of a plurality of tasks comprising a project, the received definition for a task comprising a task identifier, a relationship to at least one other of the plurality of tasks, and a range of work associated with the task;
applying a statistical model to estimate an expected task completion date for each of the plurality of tasks having a definition, wherein the statistical model is applied to the range of work associated with a task and the expected task completion date reflects a date by which the associated task will likely be completed; and
utilizing the expected task completion date for each of the plurality of tasks having a definition to calculate a schedule for the project.

44. The computer-readable medium of claim 43, wherein the statistical model is any one of a normal distribution, a beta distribution, or a log-normal distribution.

45. The computer-readable medium of claim 43, wherein the range of work is specified by an amount of time estimated to complete the task.
